(19) United States
(12) Patent Application Publication
(10) Pub. No.: US 2019/0076730 A1
(43) Pub. Date: Mar. 14, 2019

(54) ARCHITECTURAL DESIGN BLOCKS

(71) Applicant: Margaret Mary McManus, Greentown, PA (US)

(72) Inventor: Margaret Mary McManus, Greentown, PA (US)

(21) Appl. No.: 16/130,129

(22) Filed: Sep. 13, 2018

Related U.S. Application Data
(60) Provisional application No. 62/557,903, filed on Sep. 13, 2017.

(51) Int. Cl. A63F 9/12; A63H 33/06; G09B 1/16

(52) U.S. Cl. CPC A63F 9/1204; G09B 1/16; A63H 33/06

(57) ABSTRACT

A children's educational building block set that allows children to incorporate material selection, landscaping, and environment considerations into the design of an architectural feature. With the blocks of the present invention, children learn to see buildings as part of the environment and the land, and not separate from them. The set includes a plurality of building blocks formed as a geometric solid carrying indicia of a design element on a face of each block. A set of architectural material blocks permits the forming of an architectural structure, including a roofing, a siding, and a fenestration element. Foreground and landscape blocks carry indicia for a landscape or foreground to frame a base of the structure. Environmental blocks may surround a periphery of the structure.

### CROSS-REFERENCE TO RELATED APPLICATION

This application claims the benefit of priority of U.S. provisional application No. 62/557,903, filed Sep. 13, 2018, the contents of which are herein incorporated by reference.

### BACKGROUND OF THE INVENTION

The present invention relates to children's toys, and more particularly to educational toys.

Children's toys and children's educational products do very little in teaching children about the connections between the built environment, architectural materials, and the weather, climate, and the land, or setting in which it is situated. Typically blocks have been used as building blocks and do not include important aspects such as materiality, site considerations (foreground blocks), and the environment (blocks that include weather), all of which are important to consider in architectural building designs, and that are present in this invention.

As can be seen, there is a need for an improved educational toy that teaches children to consider environment, materials, weather, and foreground scenarios in a rudimentary fashion so that children can grasp their inevitable importance and existence when designing and building with different materials or when conjuring different play scenarios.

### SUMMARY OF THE INVENTION

In one aspect of the present invention, an architectural design building block set is disclosed. The building block set includes a plurality of blocks each carrying indicia on a face of the block for forming numerous architectural designs having architectural structure components, a landscape component, and an environmental component. In some embodiments, a set of blocks corresponds to each of the architectural structure components, the landscape component, and the environmental component. The set of blocks in the architectural structure component may include: a roofing set carrying indicia of a roofing material selection; a siding set carrying indicia of a siding material selection; and a fenestration set carrying indicia of selected fenestration and openings.

In other embodiments of the invention, the block set also includes a case configured to receive the plurality of blocks arranged to form the architectural design image within the case. A lid captively retains the plurality of blocks within the case. The lid has a transparent face to display the architectural design image. A frame element may be provided to surround the transparent face of the lid. A hinge may attach the lid to the case.

Each of the plurality of blocks are formed as a geometric solid, such that a face of a first block may be positioned adjacent to a face of second block so that the faces form a planar surface, when arranged in the case.

In other aspects of the invention, an architectural design building block set includes a plurality of blocks each carrying indicia on a face of the block for forming an image of an architectural design. The plurality of blocks including: an architectural structure component block set wherein the indicia corresponds to a structural building element and the blocks within the set are arrangeable to form a depiction of an architectural structure. A landscape component block set includes indicia that corresponds to a landscape feature in the depiction of the architectural structure. An environmental component block set in which the indicia corresponds to an environment surrounding the architectural structure. The architectural structure component block set includes a roofing material block set; a siding material block set; and a fenestration block set.

In other embodiments, the architectural design building block set of claim includes a case to receive the plurality of blocks formed in the image of the architectural design; and a lid to captively retain the plurality of blocks within the case, the lid having a transparent surface through which the image of the architectural design is displayed. The lid may include a frame element surrounding a peripheral edge of the image of the architectural design.

These and other features, aspects and advantages of the present invention will become better understood with reference to the following drawings, description and claims.

### BRIEF DESCRIPTION OF THE DRAWINGS

FIG. 1 is a perspective view of the invention in use.

FIG. 2A-2E are perspective views of the blocks of the invention.

FIG. 3A is an elevation view of the six sides of block 2A.

FIG. 3B-3E are elevation views of the first three sides of blocks 2B-2E.

FIG. 4 is an exploded perspective view of some of the block in use.

FIG. 5 is a front elevation of an assembly of the blocks of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a children's educational building block set that allows children to incorporate material selection, landscaping, and environment considerations into the design of an architectural feature. With the blocks of the present invention, children learn to see buildings as part of the environment and the land, and not separate from them.

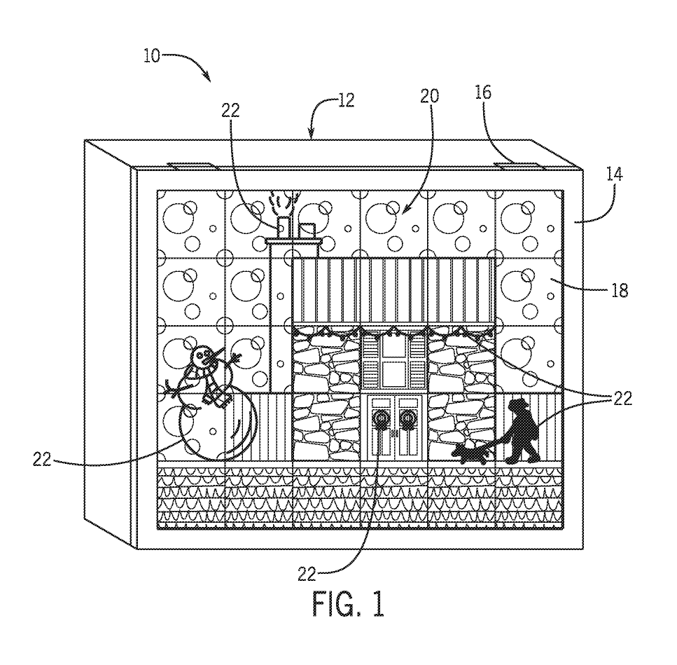

As best seen in reference to FIG. 1, the child's architectural design block set 10 of the present invention includes a display/carrying case 12 configured to receive a plurality of architectural feature blocks. A frame lid 14 permits the blocks to be captively received within the case 12. The frame lid 14 is attached to the case 12 via a hinge 16 that permits the lid 14 to be operable between an open position and a closed position.

With the frame lid 14 in the open position, the child may arrange and insert the plurality of blocks in a desired pattern, based on a set of environmental blocks 30, a set of material selection blocks 32, 34, 36, and a set of landscaping and foreground blocks 38, that permit the child to incorporate these design considerations in the selection and arrangement of the plurality of blocks. Once the child has completed their design, the lid 14 may be moved to the closed position.

In the closed position, the selection and arrangement of the child's blocks 18 are captively retained within the case 12 while the child's design project is framed for display by a transparent cover 18 integrated in an interior opening of a peripheral frame of the lid 14. The child may also draw upon the transparent cover 18, such as with an erasable ink pen, or other writing implement to add their own adornments to the scene.

The plurality of blocks may be formed as a geometric solid, such that a face of one block may be positioned adjacent to another block so that the faces form a planar surface. In the non-limiting embodiment shown, the geometric shape is shown a cubic block.

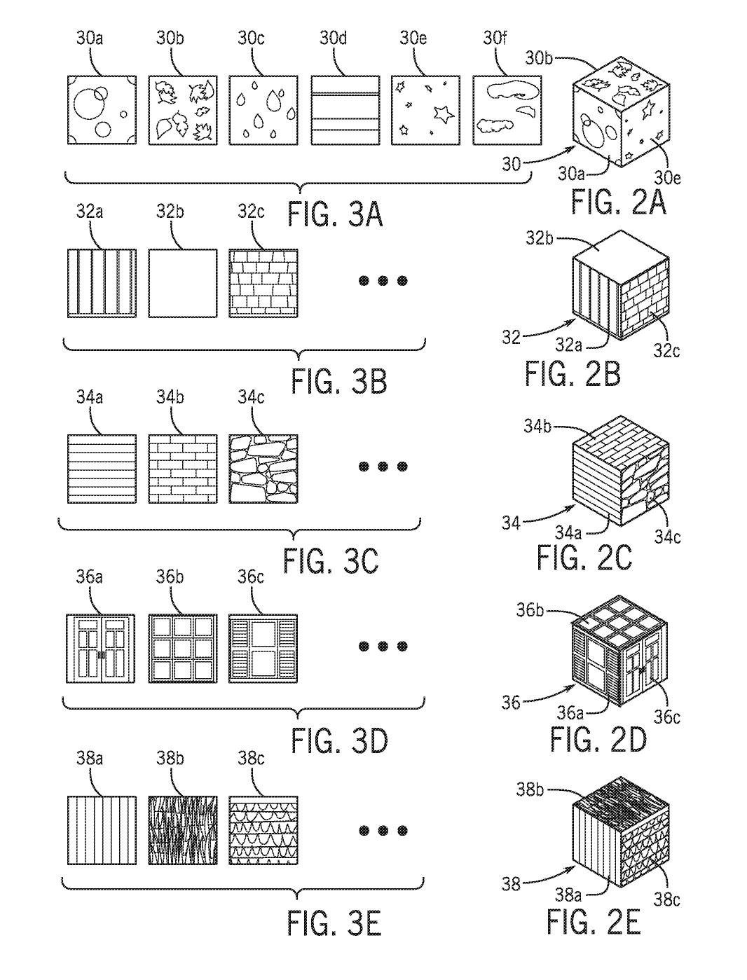

As seen in reference to FIGS. 2A-3E, the plurality of building blocks include a set of environmental blocks 30, a set of architectural material selection blocks 32, 34, 36, and a set of landscaping and foreground blocks 38. Each of the sets of blocks have a face that carries indicia representative of a design consideration for the respective block type.

By way of non-limiting example, the set of environmental blocks 30 may include faces carrying indicia for one or more of a snow pattern 30a, leaf pattern 30b, a precipitation pattern 30c, a light gradient pattern 30d, a starlight pattern 30e, or a cloud pattern 30f.

The material selection blocks may include a roofing element 32, carrying indicia representative of a variety of roofing materials, such as a metal roofing panel 32a, a glass panel 32b, a shingle panel 32c, . . . , and any desired roofing material. The material selection blocks may also include a set of siding blocks 42 carrying indicia for a desired siding material for the architectural structure, such as plank siding 34a, brick 34b, stacked stone 34c, . . . , and other suitable siding materials. The material selection blocks may also include a set of fenestration blocks 36. The fenestration blocks may include indicia representing a doorway 36a, a glass block window feature 36b, a shuttered window 36c, . . . , or other fenestration design elements.

The landscape and foreground blocks 38 are provided with indicia representing one or more landscape or foreground features for the architectural design. By way of non-limiting example, the landscape features may include indicia representing a fence or peir section 38a, a lawn element 38b, a water element 38c, . . . , or other features that may occupy a foreground of an architectural structure.

As will be appreciated with the benefit of applicant's disclosure, each of the enumerated environmental, material selection, and landscaping design considerations aren't necessarily carried on a unitary block set. The indicia may be carried on a face within the plurality of blocks such that the child may mix and match between elements. However, in preferred embodiments, the indicia are presented in block sets so that the child can learn to distinguish the architectural design elements.

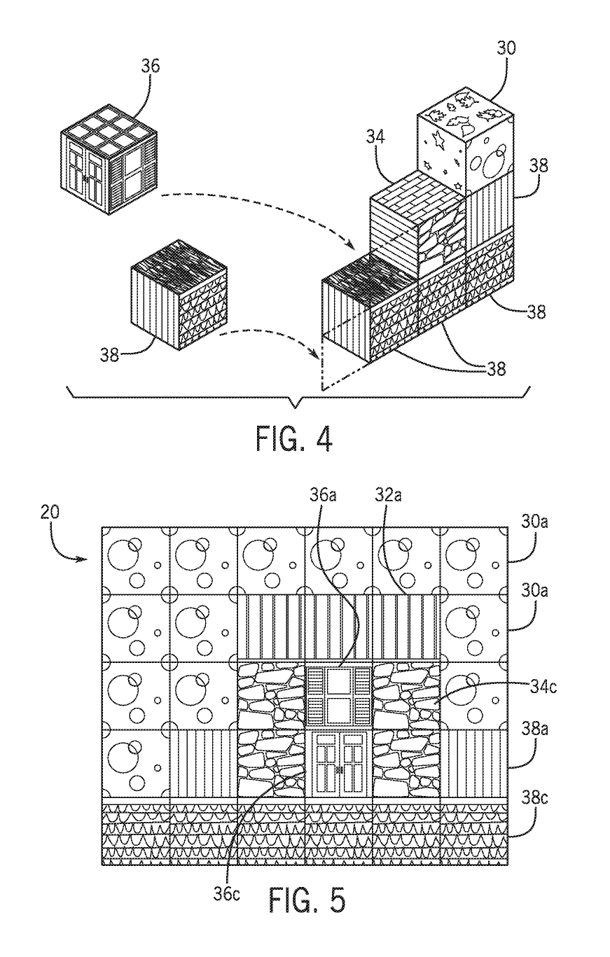

As seen in further reference to FIGS. 4 and 5, the architectural design formed by the plurality of blocks 18 includes an architectural structure element, formed from a selected roofing material block 32, a siding block 34, and a fenestration block 36. A foreground of the design is formed from a selected foreground or landscape block 38. The remaining sides of the architectural structure element may be surrounded by a desired environmental block 30.

Many other themed-blocks could be added that take on new materials, new environments, new foregrounds, etc. This idea lends itself to many additional possibilities, some of the blocks could have special characters, symbols, or otherwise, to make the arrangement of the blocks tell more of a story.

The block components could be arranged in either a portrait or a landscape orientation. Depending on the size of the case, the blocks could take on any different size format, such as a panoramic or a very tall structure, etc. Without the case 12, the blocks are not confined to a dimensional format and are only limited by the number of blocks the child has to design with, and their own imagination. Different artistic scenarios or images could also be slightly altered and placed on the blocks, and yet the block would still perform in a similar manner.

With the blocks of the present invention, the child would investigate all sides of the different blocks, and would then begin arranging them in creative ways to reveal drawings that depict architecture materials adjacent to environment and foreground. The user could create different scenarios that involve design decisions related to architectural forms, arranging siding materials next to roofing materials, next to openings, etc. in relation to the foreground and the environment.

Arrangements may be temporary and may also be placed in the case and then displayed via the case 12 through the transparent cover 18. The case 12 could also be hung on a wall to display the child's work. The present invention could also be translated into an app (application) where the blocks become virtual blocks and the child could rotate and manipulate them in a virtual space and design and display with the assistance of a digital interface.

It should be understood, of course, that the foregoing relates to exemplary embodiments of the invention and that modifications may be made without departing from the spirit and scope of the invention as set forth in the following claims.

What is claimed is:

1. An architectural design building block set, comprising:
a plurality of blocks each carrying indicia on a face of the block for forming an architectural design having an architectural structure component, a landscape component, and an environmental component.

2. The architectural design building block set of claim 1, wherein a set of blocks corresponds to each of the architectural structure component, the landscape component, and the environmental.

3. The architectural design building block set of claim 1, wherein the set of blocks in the architectural structure component comprises:
a roofing set carrying indicia of a roofing material selection;
a siding set carrying indicia of a siding material selection; and
a fenestration set carrying indicia of a selected fenestration.

4. The architectural design building block set of claim 1, further comprising:
a case configured to receive the plurality of blocks arrangeable to form the architectural design image within the case; and
a lid to captively retain the plurality of blocks within the case, the lid having a transparent face to display the architectural design image.

5. The architectural design building block set of claim 4, further comprising:
a frame element surrounding the transparent face of the lid.

6. The architectural design building block set of claim 5, further comprising:
a hinge to attach the lid to the case.

7. The architectural design building block set of claim 4, wherein each the plurality of blocks are formed as a geometric solid, such that a face of a first block may be positioned adjacent to a face of second block so that the faces form a planar surface, when arranged in the case.

8. An architectural design building block set, comprising:
a plurality of blocks each carrying indicia on a face of the block for forming an image of an architectural design, the plurality of blocks including:
an architectural structure component block set wherein the indicia corresponds to a structural building element and the blocks within the set are arrangeable to form a depiction of an architectural structure;
a landscape component block wherein the indicia corresponds to a landscape feature in the depiction of the architectural structure; and
an environmental component block set, wherein the indicia corresponds to an environment surrounding the architectural structure.

9. The architectural design building block set, of claim 8, wherein the architectural structure component block set further comprises:
a roofing material block set;
a siding material block set; and
a fenestration block set.

10. The architectural design building block set of claim 9, further comprising:
a case to receive the plurality of blocks formed in the image of the architectural design; and
a lid to captively retain the plurality of blocks within the case, the lid having a transparent surface through which the image of the architectural design is displayed.

11. The architectural design building block set of claim 10, wherein the lid further comprises:
a frame element surrounding a peripheral edge of the image of the architectural design.
